(19) United States
(12) Patent Application Publication
(10) Pub. No.: US 2015/0042101 A1
(43) Pub. Date: Feb. 12, 2015

(54) METHOD AND SYSTEM FOR CHARGING A BATTERY IN FOOTWEAR WHILE A PERSON WALKS OR RUNS AND IN CRUTCHES OR A WHEELCHAIR WHILE A HANDICAPPED PERSON MOVES

(71) Applicant: Queenie Zhu Luo, Marlboro, NJ (US)

(72) Inventor: Queenie Zhu Luo, Marlboro, NJ (US)

(21) Appl. No.: 13/960,801

(22) Filed: Aug. 7, 2013

(51) Int. Cl. H02K 7/18; F03G 5/06; H02J 7/00; H02K 7/02

(52) U.S. Cl. CPC H02K 7/1861; H02K 7/02; H02K 7/1853; F03G 5/06; H02J 7/0042
USPC 290/1 A; 320/107

(57) ABSTRACT

Described above are a system and method for footwear or crutches to convert the periodic upward and downward pressures from the lifting and dropping of the foot or body weight into low-voltage electricity that is capable of charging a battery or electronic device attached to the footwear or crutch; a similar system and method is also described for the wheelchair to convert the rotation of the wheel from the wheelchair into the rotation of the inertia wheel that can spin the motor and generate low-voltage electricity that is capable of charging a battery of electronic device attached to the arm seat of the wheelchair.

### BACKGROUND OF THE INVENTION

In the past several years, mobile electronics devices, especially smart phones, have become an essential part of daily life. They enable people to communicate, learn, and entertain anytime anywhere. Although mobile device design and manufacture technologies have improved significantly, these devices consume more and more battery power as they provide more and more functions. A big inconvenience is that these mobile devices have to be charged frequently. When people are on the road, their mobile devices often run out of battery before they can find a power source to charge them. The purpose of this invention is to solve this problem by charging batteries from natural, effortless, daily human activities.

This invention describes a method and system of charging batteries in footwear when a person walks or runs, as well as a method and system of charging batteries in crutches or a wheelchair when a handicapped person moves. It is estimated that a 75 kg adult who walks about 2000 steps a day can generate up to 14700 joules by lifting and dropping his feet by about 1 cm each step (2000×mgh=2000×75 kg×9.8 m/s²×0.01 m=14700 joules). With a conservative estimate of 30% energy conversion efficiency, this amount of energy (14700*0.3=4410 joules) is sufficient to power a 100 mW mobile device (a MP3 player in playback mode or a cell phone largely in its standby mode and occasionally in voice calls or data connections) for about 44100 seconds, i.e., about a half day. As a reference, an iPhone5's battery capacity is 1440 mAh, or 5.45 Wh, or 19620 joules, which normally can power such a device for 2 days before a charge is needed.

### SUMMARY OF THE INVENTION

A method for converting periodic pressure changes under human feet while a person walks or runs into low-voltage electricity, which powers up a charging circuit to charge a battery.

A method for converting periodic pressure changes under crutches while a handicapped person walks into low-voltage electricity, which powers up a charging circuit to charge a battery.

A system consisting of a low-voltage electricity generator operating due to periodic pressure changes, a charging circuit, and a battery built into footwear such as shoes, socks, shoe soles, or crutches for handicapped people.

A system consisting of a low-voltage electricity generator operating due to periodic pressure changes and a charging circuit, both built into footwear, and an electronic device attached to the footwear that receives power from the charging circuit.

A system consisting of a low-voltage electricity generator that operates due to the wheelchair's wheel rotation, a charging circuit, and a battery.

A system consisting of a low-voltage electricity generator that operates due to the wheelchair's wheel rotation and a charging circuit, both attached to a wheelchair, and an electronic device that receives power from the charging circuit.

As an embodiment of generating low-voltage electricity from periodic pressure changes, a mechanical device consists of a shoe sole, a transmission that utilizes an inertia wheel to convert vertical movement into rotation, a spring, and an electromagnetic motor built into the footwear. The shoe sole takes the downward pressure when the foot drops against the ground with each step. This pressure compresses the sole by about 10 mm, which drives the transmission to convert the vertical movement into high-speed rotation and forces an inertia wheel spin. The inertia wheel keeps the electromagnetic motor in rotation for an extended period of time (several seconds) after the sole has been compressed, which generates low-voltage electricity. When the foot is lifted, the downward pressure applied to the sole disappears, and the spring underneath the sole pushes the sole up by 10 mm back to its original position. The sole will be compressed by 10 mm again when the foot drops against the ground in the next step and pushed up to its original position again when the foot is lifted, thus creating a cycle. As such, with the help of the inertia wheel, the mechanical device can keep the electromagnetic motor rotating continuously as long as the person walks, runs, or engages in any activity that involves the use of repetitive lift-compress foot motions. This continuous generation of low-voltage current can power the charging circuit, which in turn charges the battery or the attached mobile device.

As another embodiment of generating low-voltage electricity from periodic pressure changes, an array of piezoelectric ceramic devices can be built into footwear to convert pressure changes into low-voltage electricity.

As yet another embodiment of generating low-voltage electricity from periodic pressure changes, an array of electromagnetic devices, each consisting of a magnetic cylindrical core attached to the top of the sole that can move up and down in a surrounding cylinder wrapped with wires, a shoe sole that can use the pressure from the foot to push the magnetic cylinder down, a spring that can push the magnetic cylindrical core back up when the foot is lifted, and a charging circuit, can be built into footwear. The wires wrapped around the outer cylinder can generate low-voltage current when the magnetic cylinder moves in and out of the hollow cylinder as the person walks or runs.

All above embodiments can be built into crutches for handicapped people instead of into footwear for ordinary people.

As an embodiment of generating low-voltage electricity from wheelchair movements, the mechanical device consists of a transmission attached to the rotating wheel of a wheelchair, an electromagnetic motor, and a charging circuit. The transmission converts the wheel rotation into internal high-speed rotation that drives the electromagnetic motor, which generates low-voltage current as the wheelchair moves.

### BRIEF DESCRIPTION OF THE DRAWINGS

FIGS. 1a, 1b, and 1c show an exemplary embodiment of a system according to the present invention as described in Paragraph 9. FIG. 1a shows the shoe sole during the moment in which the foot is in its lifting position. No rotation and energy conversion is created. FIG. 1b shows the shoe sole during the moment in which the foot is pressing against the ground, therefore compressing the system. FIG. 1c is a top view of the shoe sole, transmission, and motor.

FIG. 2 shows an exemplary embodiment of a system according to the present invention as described in Paragraph 10.

FIG. 3a and FIG. 3b show an exemplary embodiment of a system according to the present invention as described in Paragraph 11. FIG. 3a shows the shoe sole during the moment in which the foot is in its lifting position. FIG. 3b shows the shoe during the moment in which the foot is pressing against the ground.

FIG. 4 shows an exemplary embodiment of a system according to the present invention as described in Paragraph 13. The device is attached to the arm seat of the wheelchair as it gains rotation from the spinning of the wheel.

### DETAILED DESCRIPTION

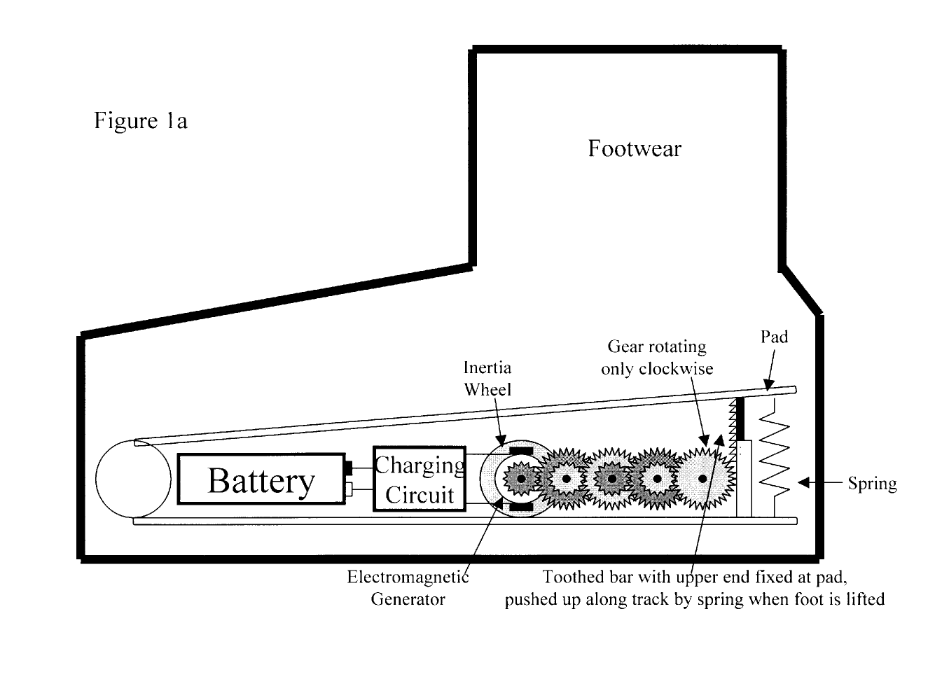

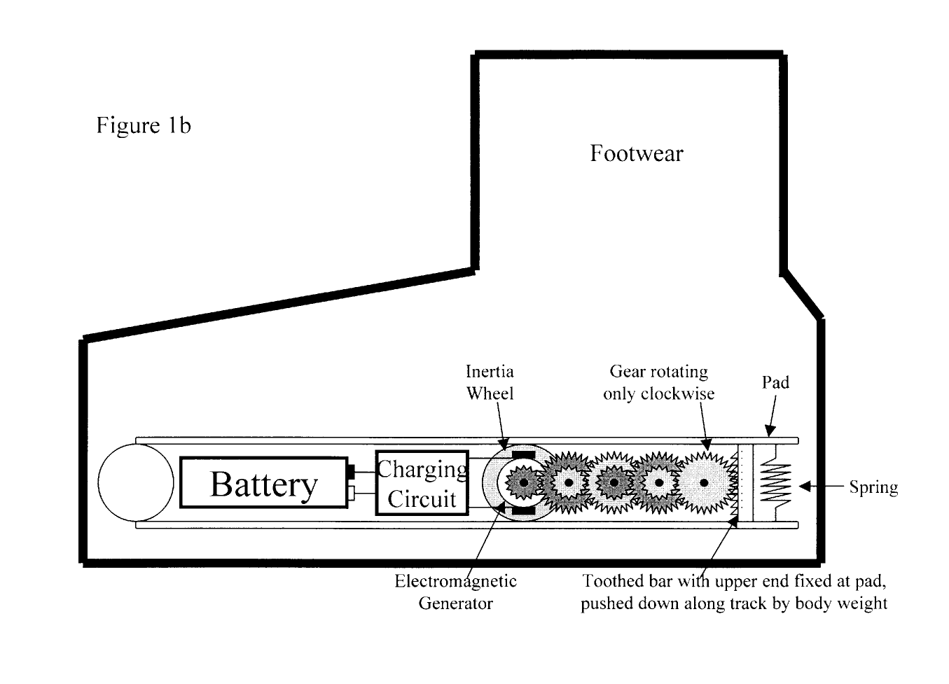

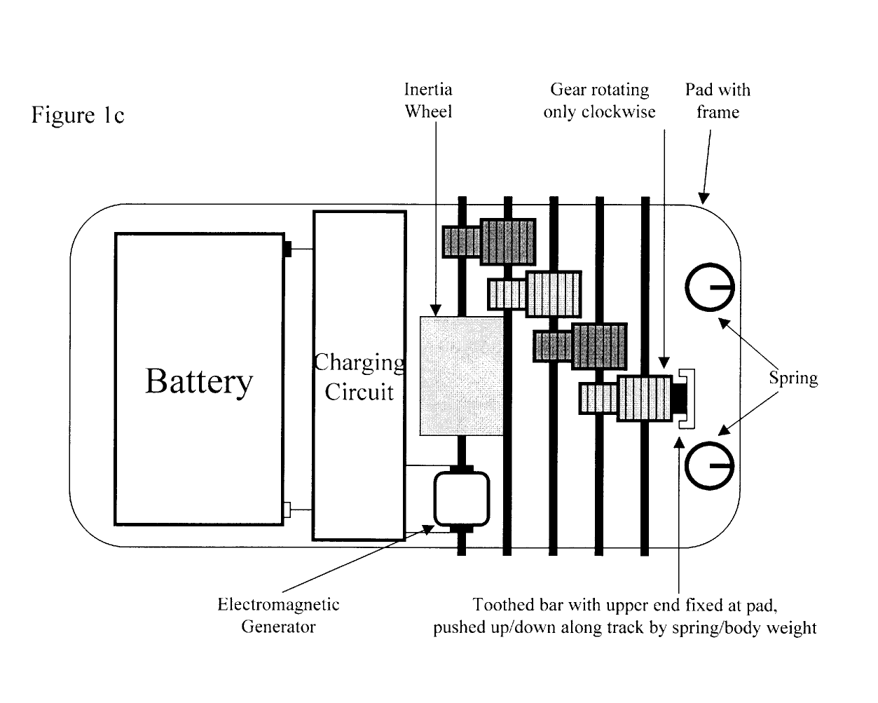

As shown in FIG. 1a, an exemplary embodiment of the footwear charging system comprising a mechanical device located within a shoe sole that is in its lifting phase of a walking step. The springs are in their normal states. In FIG. 1b, the shoe sole is in its compressed phase of the step with the springs squeezed tightly together; the downward pressure of the dropping of the foot causes the toothed bar to travel down along a guide track; the teeth push the teeth of the first gear and make the first gear rotate, which rotates the second small gear, that in turn, rotates the axle it is on, thereby turning the next large gear on the axle that is connected to a smaller gear that rotates the axle it is on and so on, until the final gear within the transmission turns the inertia wheel that can power the motor at high speed for a few seconds by each downward movement from the toothed bar. When the foot is lifted, the downward pressure on the shoe sole disappears. The spring then pushes the shoe sole and the toothed bar back into original position. During this process, the first gear can freely rotate and does not rotate its axle due to a unidirectional design (this design widely exists, which is not a focus of this invention), so the shoe sole and the toothed bar can quickly return to their original positions, waiting to be pushed down by the next dropping of the foot; during this time, the inertia wheel continues to spin before it is accelerated by the next dropping of the foot. As such, as the person continuously walks or runs at a reasonable step frequency, the inertia wheel keeps spinning all the time, thus generating continuous low-voltage electricity that can power the charging circuit and charge the battery continuously. FIG. 1c is a top view of the device. It shows the placement of each of the gears and axles along with the springs, inertia wheel, motor, charging circuit, and battery. The battery can then be used to power an electronic device. The charging circuit is illustrated as a black box, as it is a priori art, not a focus of this invention.

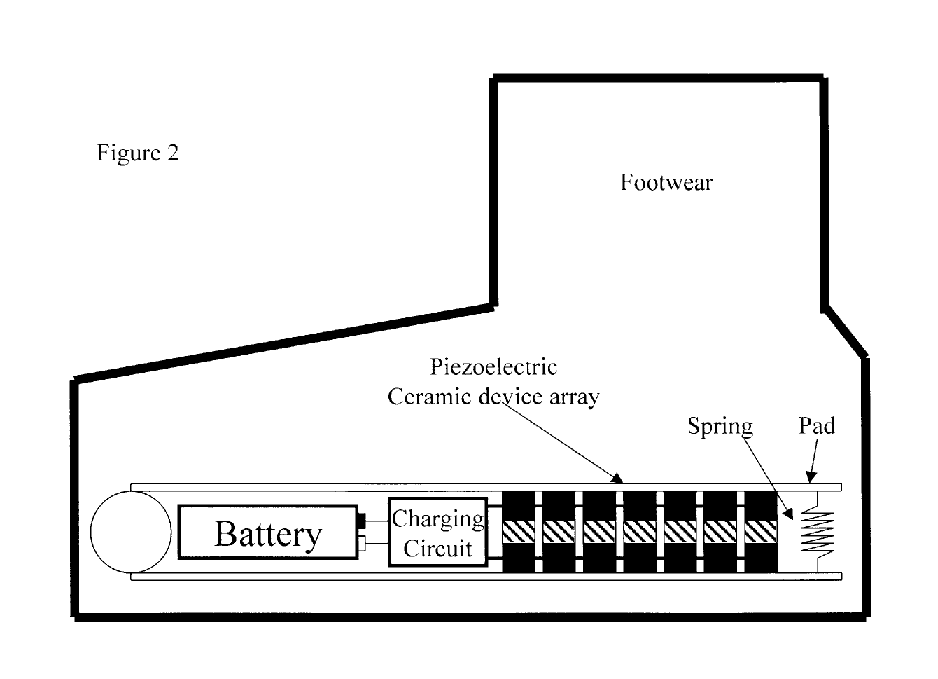

As shown in FIG. 2, another exemplary embodiment of the footwear charging system is comprised of an array of piezoelectric ceramic devices located within the shoe sole. As the foot alternatively lifts and drops, it creates periodic downward pressure changes onto every piezoelectric ceramic device that in turn generates low-voltage electricity. The electricity from every piezoelectric ceramic device is aggregated to power the charging circuit to charge a battery.

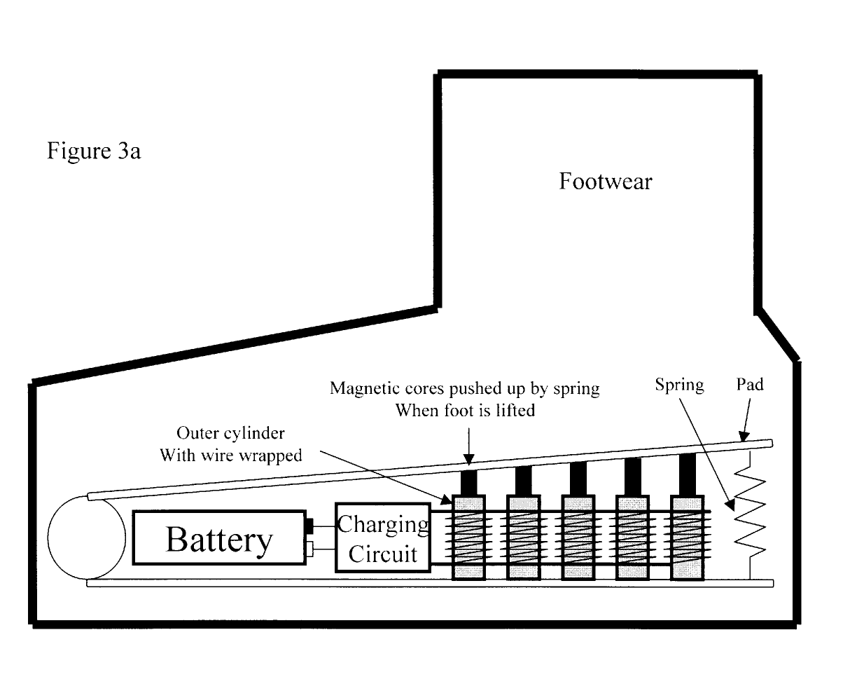

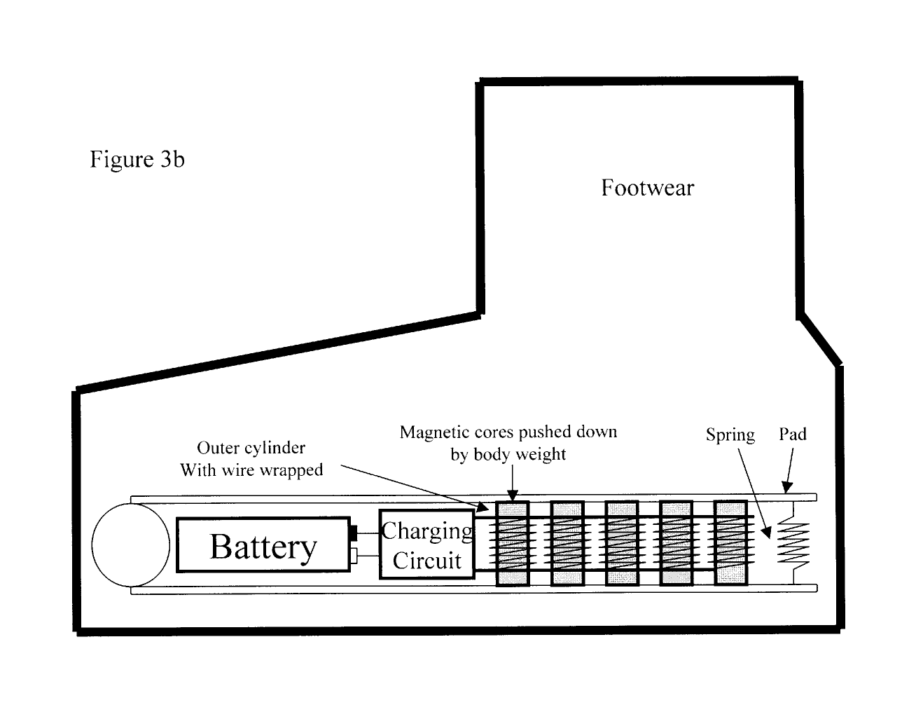

As shown in FIG. 3a, another exemplary embodiment of the footwear charging system is located within the shoe sole in its lifting phase of the step. It consists of a multitude of smaller devices that are each made up of a magnetic cylindrical core attached to the ceiling of the sole and a hollow cylinder with wires wrapped around it. The magnetic cylindrical core is pushed by a spring underneath to the upper position in the hollow cylinder when the foot does not apply any downward pressure. As shown in FIG. 3b, the shoe sole is in its compressed phase by the downward pressure from the dropping foot. The magnetic cylindrical core is forced down into the surrounding cylinder wrapped in wires. When the foot lifts, the downward pressure disappears, and the spring underneath the magnetic cylindrical core pushes the core back to the upper position again. When the foot drops, the magnetic cylindrical core is pushed down to the surrounding cylinder again. This alternative up-and-down movement of the magnetic core inside the surrounding cylinder will generate low-voltage current in the wires wrapped on the surrounding cylinder. The electricity from every surrounding cylinder is aggregated to power the charging circuit to charge a battery.

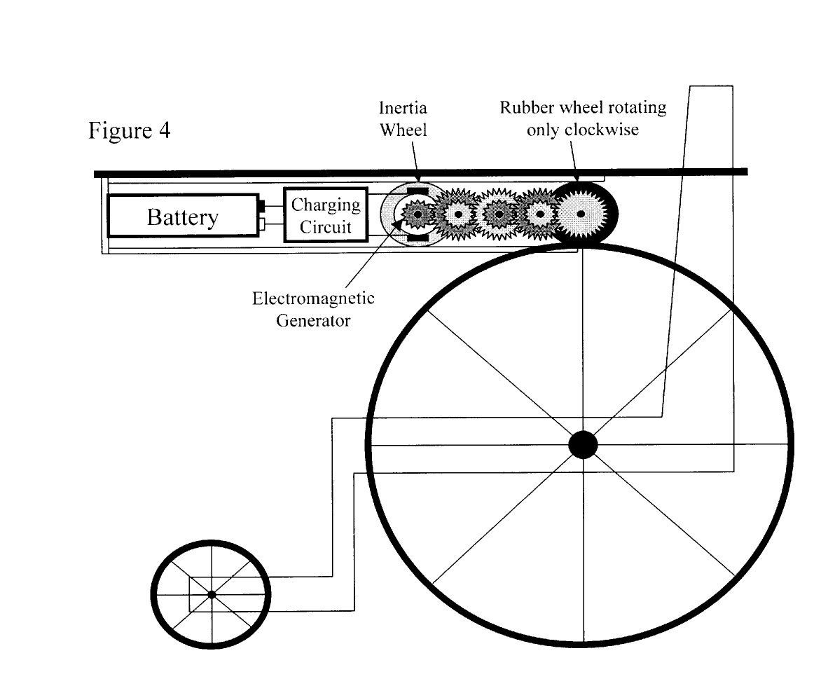

As shown in FIG. 4, an exemplary embodiment of a wheelchair charging system is attached to the arm seat of the wheelchair, which consists of a gear attached to the wheelchair's wheel, a transmission with a few gears, an inertia wheel, a motor, and a charging circuit. As a handicapped person maneuvers him or herself in the wheelchair by rotating the wheels, the gear attached to the wheels is made rotating too. After a few gear-up transmissions, the inertia wheel is made spinning, which drives the motor to generate low-voltage electricity to power the charging circuit to charge a battery or an electronic device.

What is claimed is:

1. A method comprised of:
receiving downward pressure from feet in footwear periodically;
converting the periodic downward pressure into low-voltage electricity, and
charging a battery or an electronic device attached to the footwear.

2. The method of claim 1, wherein the footwear is shoes, shoe soles, socks, or crutches.

3. The method of claim 1, wherein the conversion is completed via a mechanical device that converts downward vertical movement into the rotation of an inertia wheel that drives a motor to generate low-voltage electricity.

4. The method of claim 1, wherein the conversion is completed via an array of piezoelectric ceramic devices that convert periodic downward pressure into low-voltage electricity.

5. The method claim 1, wherein the conversion is completed via an array of vertical electromagnetic cylinders.

6. A method comprised of:
receiving rotation force from the wheel of a wheelchair;
converting the rotation into low-voltage electricity, and
charging a battery or an electronic device with the electricity.

7. The method of claim 6, wherein the conversion is completed via a mechanic device that drives a motor using the rotation from the wheel of a wheelchair to generate low-voltage electricity.

8. A system comprised of:
a sole or bottom surface receiving periodic downward pressure from a foot or a crutch;
a transmission converting vertical downward movements into the rotation of an inertia wheel;
a motor generating low-voltage electricity from the rotation of the inertia wheel;
a charging circuit receiving low-voltage electricity from the motor capable of charging a battery or an electronic device; and
a spring pushing the sole back to its original position when the downward pressure is removed.

9. The system of claim 8 can be built in shoes, shoe soles, socks, or crutches.

10. A system comprised of:
a sole or bottom surface receiving periodic downward pressure from a foot or a crutch;
an array of piezoelectric ceramic devices converting periodic pressure change into low-voltage electricity; and
a charging circuit receiving low-voltage electricity from the array of piezoelectric ceramic devices capable of charging a battery or an electronic device.

11. The system of claim 10 can be built in shoes, shoe soles, socks, or crutches.

12. A system comprised of:
a sole or bottom surface receiving periodic downward pressure from a foot or a crutch;
an array of electromagnetic devices that can generate low-voltage electricity by moving a magnetic cylindrical core in and out of an outer cylinder wrapped with wires;
each cylindrical core is pushed down by pressure from the foot or crutch and moved back into place by a spring underneath; and
a charging circuit receiving low-voltage electricity from the array of electromagnetic devices capable of charging a battery or an electronic device.

13. The system of claim 12 can be built in shoes, shoe soles, socks, or crutches.

14. A system comprised of:
a transmission converting the rotation from a wheel of a wheelchair into the rotation of an inertia wheel;
a motor generating low-voltage electricity from rotation of the inertia wheel; and
a charging circuit receiving low-voltage electricity from the motor capable of charging a battery or an electronic device.
